(19) United States
(12) Patent Application Publication
(10) Pub. No.: US 2013/0020024 A1
(43) Pub. Date: Jan. 24, 2013

(54) APPARATUS AND METHOD FOR OIL REPELLENT MICROPOROUS FILM

(71) Applicants: Wayne Skankey, Portland, OR (US); Jen Hsien Tin, Taipei (TW)

(72) Inventors: Wayne Skankey, Portland, OR (US); Jen Hsien Tin, Taipei (TW)

(73) Assignee: COLUMBIA SPORTSWEAR NORTH AMERICA, INC., Portland, OR (US)

(21) Appl. No.: 13/553,522

(22) Filed: Jul. 19, 2012

Related U.S. Application Data
(60) Provisional application No. 61/591,728, filed on Jan. 27, 2012.
(60) Provisional application No. 61/510,428, filed on Jul. 21, 2011.

(51) Int. Cl. B32B 38/00

(52) U.S. Cl. 156/280; 156/60; 156/307.3

(57) ABSTRACT

In various embodiments, a microporous film for a fabric and method of producing the microporous film are provided. The microporous film may be treated with a treatment agent. In some embodiments, the microporous film may be treated prior to the film being applied to the fabric. In other embodiments, the treatment agent may be applied to an exposed side of the film after the film is laminated to the fabric. The treatment agent may include a relatively high concentration of an oil repellent (oleophobic) component to increase the oleophobicity of the film. Additionally, the treatment agent may include a high concentration of a wetting component, such as isobutyl alcohol (IBA) and/or isopropyl alcohol (IPA), to facilitate absorption of the oleophobic component by the film and/or penetration of the oleophobic component into the micropores of the film.

### CROSS REFERENCE TO RELATED APPLICATIONS

The present application claims priority to U.S. Provisional Patent Application No. 61/591,728, filed Jan. 27, 2012, entitled “Apparatus and Method for Oil Repellent Micro-Porous Film,” and U.S. Provisional Patent Application No. 61/510,428, filed Jul. 21, 2011, entitled “Oil Repellent Finishing of Micro-Porous Film,” the entire disclosures of which are hereby incorporated by reference in their entirety.

### TECHNICAL FIELD

Embodiments herein relate to microporous films for fabrics and in particular to oil repellent microporous films for fabrics.

### BACKGROUND

Currently a number of waterproof breathable (WPB) films are laminated to fabrics to create a fabric for use in outerwear that is generally both waterproof and breathable. Examples of such materials include polytetrafluoroethylene (PTFE) and polyethylene (PE). Because these WPB films are generally oleophilic they tend to attract contaminants such as oils, detergents, etc., which in turn compromises the film micropores. The effect of this contamination tends to make the film more hydrophilic, which dramatically lowers the waterproofness of the fabric.

Some WPB films are treated with an oil repellent (i.e., oleophobic) chemical. However, the WPB film is naturally hydrophobic and rejects the chemical, making it difficult to obtain a high level of oil repellency. Furthermore, the fabric to which the film is laminated is more absorbent than the film and absorbs most of the oil repellent chemical. This further decreases the amount of the oil repellent chemical absorbed by the film, and increases the stiffness of the fabric.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 illustrates a flow diagram of a method of producing an oil repellent treatment agent and applying the treatment agent to a microporous film, in accordance with various embodiments; and

FIG. 2 illustrates a kiss roller for applying an oil repellent treatment agent to a microporous film in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form at least one of A, B, and C″ means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

In various embodiments, a microporous film for a fabric and method of producing the microporous film are provided. The microporous film may be treated with a treatment agent to provide increased oil repellency. The treatment agent may include a relatively high concentration of an oil repellent (oleophobic) component to increase the oleophobicity of the film. Additionally, the treatment agent may include a high concentration of a wetting component, such as isobutyl alcohol (IBA) and/or isopropyl alcohol (IPA), to facilitate absorption of the oleophobic component by the film and/or penetration of the oleophobic component into the micropores of the film. The high concentration of oil repellent component and/or wetting component may provide a higher pick-up of the oleophobic component by the film compared with prior methods.

The application of the treatment agent to the film may create a film having a high oil repellency. For example, the oil repellency of the film described herein may have an improvement of about one full point under Test Method 118 of the American Association of Textile Chemists and Colorists (AATCC 118). In a test performed using AATCC 118, a PE film treated according to the method described herein was found to have a level of oil repellency of 6A, compared with an oil repellency of 5B using prior techniques.

In some embodiments, the film may be laminated to the fabric, leaving an exposed side of the film. The treatment agent may be applied to the exposed side of the film after the film is laminated to the fabric. The fabric may stabilize the film to facilitate application of the treatment agent. In some embodiments, the treatment agent may be applied to the exposed side of the film by a kiss roller. Applying the treatment agent to the exposed side of the film only may prevent and/or reduce the absorption of the treatment agent by the fabric. Accordingly, a higher concentration of oil repellent component and/or wetting component may be used.

In other embodiments, the treatment agent may be applied to the film separately (e.g., prior to lamination of the film to the fabric). This may prevent the treatment agent from being absorbed by the fabric.

In various embodiments, the microporous film may be a waterproof breathable (WPB) film (also referred to as a membrane). For example, in some embodiments, the WPB film may be made from polyethylene (PE) and/or polytetrafluoroethylene (PTFE).

The film may be laminated to the fabric by any suitable method, such as dot lamination. For example, the film may be applied to the fabric by a hot glue dot melt process, whereby heat and pressure are applied to induce lamination.

The film and fabric may combine to form a multi-layer waterproof breathable material. In some embodiments, additional layers may be added to the film and/or fabric. For example, the multi-layer material may be a 2-layer material or a 3-layer material.

The waterproof breathable material may be highly oil repellent (i.e., have high oleophobicity) on account of the treatment with the treatment agent. The oil repellency of the film may prevent contamination, thereby preserving the waterproofness of the film and/or the fabric. The waterproof breathable material may be suitable for a wide variety of applications, such as garments (e.g., outerwear, footwear, gloves, hats, etc.) and/or outdoor sports articles (e.g., tents, backpacks, sleeping bags, luggage).

The treatment agent may include a number of components designed to help enhance the oil and/or water repellency of the film. In an embodiment, the treatment agent may include one or more of an oleophobic component (e.g., an oil repellent fluorocarbon), a cross-linking polymer (e.g., TP-10), a wetting component (e.g., IBA and/or IPA), and/or water. The concentration of the oleophobic component and/or the wetting component in the treatment agent may be substantially increased compared with prior treatment compounds. For example, prior treatment compounds included up to 10% of oleophobic component and 1% to 2% of wetting agent. The treatment agent as described herein may include a concentration of oleophobic component of 25% or more (such as 30% or more in some embodiments), and/or a concentration of wetting agent of 20% or more. The concentration of cross-linking polymer may be similar to the concentrations used in prior treatment agents, and the concentration of water may be decreased.

The higher concentration of oleophobic component and/or wetting component is enabled because the film may be treated without significantly exposing the fabric to the treatment agent (e.g., by treating only the exposed side of the film and/or treating the film prior to being laminated to the fabric). The film may have a significantly lower absorbency than the fabric. A high concentration of oleophobic component and/or wetting component would normally be avoided in a textile mill, because it would make the fabric absorb too much chemical, thereby creating a risk of fire due to increased flammability. Additionally, if the fabric is exposed to a high concentration of oleophobic component and/or wetting component, the fabric may become stiff.

Accordingly, treating the film with the treatment agent without exposing the fabric to the treatment agent (e.g., by applying the treatment agent only to the exposed side of the film and/or treating the film separately from the fabric) may allow a higher concentration of the oleophobic component and/or wetting component to be used. The higher concentration of the oleophobic component and/or wetting component may allow the film to absorb more of the oleophobic component, thus imparted better oleophobicity to the treated fabric. For example, the oleophobicity may be improved by about one full point according to the AATCC118 oil drop test.

In one non-limiting example, the concentration of the oleophobic component, as measured in percentage by weight and/or percentage by volume of the treatment agent, may be greater than or equal to 25%, such as greater than or equal to 30%. Due to the hydrophobic nature of the film, the wetting component may have a sufficiently high concentration to ensure sufficient penetration into the pores of the film by the water carrying the fluorocarbons. Below about 20%, there may be an insufficient amount of wetting component to obtain proper penetration. In some embodiments, the concentration of wetting component, as measured in percentage by weight and/or percentage by volume, may be greater than or equal to about 20%, such as about 25%. In one embodiment, the concentration of wetting component may be greater than or equal to 30%, such as about 35%.

In one embodiment, the formula for the treatment agent is as follows (Table 1):

TABLE 1

Concentration

| Component | Range | Example |
|---|---|---|
| Oleophobic component | 25%-40% | ~30% |
| Cross linking polymer | 0%-5% | ~1% |
| Wetting component | 20%-45% | ~21% |
| Water | 10%-40% | ~48% |

Any suitable oleophobic components, cross linking polymers, and wetting components may be used. For example, suitable oleophobic components may include AG-E060, which is a fluorinated olephobic compound manufactured by AsahiGuard, E082 from AsahiGuard, and/or Unidyne TG5543 and/or TG-5541 from Daikin. The cross linking polymer may include TP-10, manufactured by AsahiGuard, Meikanate ST from Meisei Chemical, and/or Faragent CL324 from Farsmart.

The wetting component may be, for example, IBA and/or IPA. In some embodiments, IBA may be preferred for the wetting component because IBA may be more stable than IPA due to having a higher boiling point of 108 degrees Celsius (compared with 82.4 degrees Celsius for IPA). The higher boiling point makes IBA evaporate slower, which may help maintain titration. Additionally, IPA may have a higher risk of flammability than IBA.

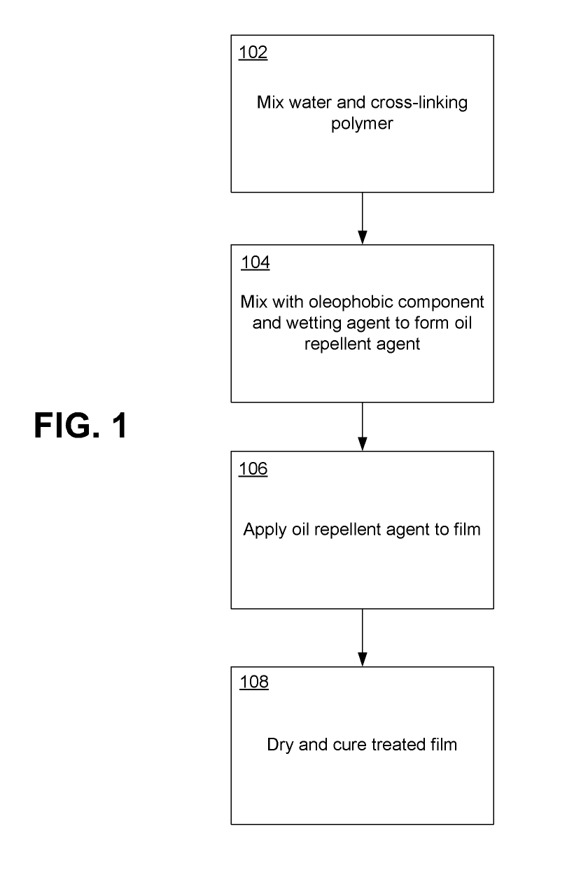

Referring to FIG. 1, a method of producing a treatment agent and applying the agent to a fabric is provided. In some embodiments, the treatment agent may be produced in a process having at least two mixing operations. In a first mixing operation 102, the water and cross linking polymer may be combined and mixed. Then, in a second mixing operation 104, the oleophobic component and wetting component may be mixed with the solution from operation 102 to create the treatment agent. In some embodiments, the wetting component may be combined in the first mixing operation 102 and/or in another mixing operation. In some embodiments, the first mixing operation 102 and/or second mixing operation 104 may be performed at normal room temperature.

It has been found that mixing the cross linking polymer and water prior to adding the oleophobic component may reduce and/or eliminate the cross linking polymer from causing portions of the treatment agent to solidify over time. For example, in some circumstances, the active agent of the cross linking polymer may bond with itself, thereby changing the titration of the solution and creating globs of the oleophobic chemical. Mixing the cross linking polymer with water in the first mixing operation 102 prior to mixing in the oleophobic component in the second mixing operation 104 may prevent/reduce this solidification. This may be particularly beneficial when a large amount of film is treated (e.g., over about 500 yards). If the treatment agent were mixed in a different sequence from the sequence describe above, the cross linking polymer may cause portions of the treatment agent to solidify over time. The solidification may build up on the application roller, and potentially cause damage and/or interfere with the application of the treatment agent to the film.

In other embodiments, the treatment agent may be produced in a single operation by mixing together all the ingredients at the same time.

After the treatment agent is produced, the agent may be applied to a microporous film, such as a polyethylene film, in an application step 106. The agent may be applied to one or both faces of the film using a roller, such as a kiss roller, and/or another application mechanism, such as a spray application.

The treated film may then be dried and/or cured during a curing step 108. In some embodiments, the treated film may be cured in an oven at a curing temperature. In one embodiment in which the film is treated separately from the fabric (e.g., prior to lamination of the film to the fabric), the curing temperature may be about 55 degrees Celsius (55 C.) to about 65 C., such as about 60 C. A curing temperature significantly higher than 60 C. or 65 C. may cause substantial shrinkage of the film.

In one embodiment in which the film is laminated to the fabric prior to application of the treatment agent, the treated film may be cured at a curing temperature of about 95 C. to about 105 C., such as about 100 C. In some embodiments, the treated film may be cured for about one to two minutes. The lamination of the film to the fabric prior to curing may prevent the film from shrinking substantially.

In some embodiments, the application 106 and curing 108 of the treatment agent may be performed by an automated finishing machine. The finishing machine may include one or more rollers for applying the agent, and may transport the treated film via belts or otherwise to and/or through a dryer/oven for drying and curing.

In some embodiments, the application 106 and/or curing 108 of the treatment agent may be repeated one or more times. For example, the treatment agent may be applied and cured to the film twice. Repeating the application 106 and/or curing 108 may improve the oleophobicity of the film.

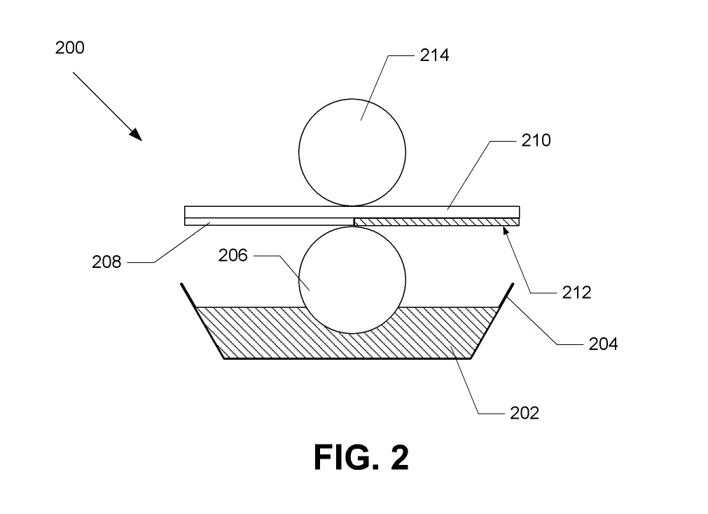

FIG. 2 illustrates a kiss roller 200 suitable to apply a treatment agent 202 in accordance with various embodiments. The treatment agent 202 may be placed in a trough 204. In some embodiments the treatment agent may be produced in the trough by one or more mixing operations as described above. In other embodiments, the treatment agent 202 may be produced and then placed in the trough 204.

A first roller 206 may be partially immersed in the treatment agent 202. In some embodiments, the first roller 206 may be a gravure roller. The first roller 206 may include a pad, such as comprised of an absorbent material, which absorbs the treatment agent 202. A film 208 may be disposed on top of the first roller 206. In some embodiments, the film 208 may be laminated to a fabric 210. In other embodiments, the film 208 may be passed through the kiss roller 200 separately (e.g., prior to being coupled to the fabric 210). The first roller 206 may rotate, thereby bringing the treatment agent 202 in contact with an exposed side 212 of the film 208. In some embodiments, the kiss roller 200 may include a second roller 214 to facilitate application of the treatment agent 202 to the film 208.

The treatment agent 202 may include a high concentration of oleophobic compound and/or wetting component to facilitate absorption of the oleophobic compound by the film 208. In some embodiments, the kiss roller 200 may apply the treatment agent 202 to the exposed side 212 of the film 208 with minimal or no penetration of the treatment agent 202 to the fabric 210. Accordingly, a film 208 with high oil repellency may be achieved without causing the fabric 210 to become stiff. In one embodiment, the film 208 may have an oil repellency of about 6A.

In some embodiments, additional treatment operations may be performed to the film 208 and/or fabric 210. For example, a durable water repellent (DWR) treatment may be applied to the film 208 and/or fabric 210. In some embodiments, the DWR treatment may be combined with the application of the treatment agent 202. The DWR treatment may include about 8% concentration of DWR chemical and about 1% concentration of cross linking agent. In some embodiments, the DWR chemical may be combined with the treatment agent described herein. Alternatively, the DWR treatment may be applied separately from the oleophobic treatment agent. The DWR treatment may be applied by any suitable mechanism, such as passing the film 208 and/or fabric 210 through a pad and/or bath followed by one or more nip rollers, by a kiss roller application, and/or by a spray application.

In various embodiments, the film 208 and fabric 210 may combine to form a multi-layer waterproof breathable material. In some embodiments, the waterproof breathable material may be a 2-layer or 3-layer material. The film may be applied to the fabric by any suitable means, such as dot lamination. For example, the film may be applied to the fabric by a hot glue dot melt process, whereby heat and pressure are applied to induce lamination.

The waterproof breathable material may be highly oil repellent (i.e., have high oleophobicity) on account of the treatment with the treatment agent. The oleophobicity of the film 208 may prevent contamination, thereby preserving the waterproofness of the film 208 and/or the fabric 210. The waterproof breathable material may be suitable for a wide variety of applications, such as garments (e.g., outerwear, footwear, gloves, hats, etc.) and/or outdoor sports articles (e.g., tents, backpacks, sleeping bags, luggage).

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A method, comprising:
applying a treatment agent to a microporous film, the treatment agent having a concentration of an oleophobic component of at least 25%, and having a concentration of a wetting component of at least 30%; and
laminating the microporous film to a fabric to form a waterproof breathable fabric.

2. The method of claim 1, further comprising producing the treatment agent by first mixing together the wetting component, water, and a cross linking polymer, and then mixing with the oleophobic component.

3. The method of claim 1, wherein the wetting component comprises isopropyl alcohol.

4. The method of claim 1, wherein the wetting component comprises isobutyl alcohol.

5. The method of claim 1, further comprising curing the treated film.

6. The method of claim 5, further comprising repeating the applying of the treatment agent to the film and the curing of the treated film.

7. The method of claim 1, wherein the treatment agent is applied to the microporous film before the microporous film is laminated to the fabric.

8. The method of claim 1, wherein the applying the treatment agent to the microporous film includes applying the treatment agent to an exposed side of the microporous film after the microporous film is laminated to the fabric.

9. The method of claim 1, wherein the treatment agent is applied to the film by a kiss roller.

10. The method of claim 1, wherein the microporous film comprises a waterproof breathable microporous film.

11. A method, comprising:
laminating a microporous film to a fabric, the film having an exposed side; and
applying a treatment agent to the exposed side of the film, the treatment agent having a concentration of an oleophobic component of at least 25%.

12. The method of claim 11, wherein the treatment agent is applied to the film by a kiss roller.

13. The method of claim 11, further comprising manufacturing the treatment agent by first mixing together water and a cross linking polymer, and then mixing with the oleophobic component.

14. The method of claim 11, wherein the treatment agent has a concentration of a wetting component of at least 20%.

15. The method of claim 14, wherein the wetting component comprises isobutyl alcohol.

16. The method of claim 14, wherein the concentration of oleophobic component is about 30% and the concentration of the wetting component is about 21%.

17. The method of claim 11, wherein the film comprises polyethylene.
